(19) United States
(12) Patent Application Publication
(10) Pub. No.: US 2006/0123411 A1
(43) Pub. Date: Jun. 8, 2006

(54) Rendering device installation methods and systems

(75) Inventors: Mark L. Hanson, Tigard, OR (US); David M. Chapin, Gresham, OR (US); Jonathan Edmonds, Silverton, OR (US); Patrick Kevin Sheehan, Clackamas, OR (US); Matthew DeRoller, Webster, NY (US); Krishna Kumar, Rochester, NY (US); Krishna Cherukupalli, (US)

Correspondence Address: ORTIZ & LOPEZ, PLLC;Patent Attorneys, P.O. Box 4484, Albuquerque, NM, 87196-4484, US

(73) Assignee: Xerox Corporation.

(21) Appl. No.: 11/006,352

(22) Filed: Dec. 6, 2004

(51) Int. Cl. G06F 9/445

(52) U.S. Cl. 717/174

(57) ABSTRACT

Methods and systems for configuring and installing a rendering device in communication with a computer network that includes one or more clients and one or more servers are disclosed. In general, a driver associated with a rendering device can be installed and configured based on driver data and associated information maintained with a central repository within the computer network. Such a methodology requires minimum user intervention. A user can select a rendering device for installation, which triggers automatic installation of the rendering device based on the best-possible rendering device installation mechanisms available. The appropriate driver and installation settings can then be downloaded and selected. The administrator controls which rendering device installation mechanisms are allowed on the computer network and which are not.

### TECHNICAL FIELD

Embodiments are generally related to data-processing methods and systems. Embodiments are also related to rendering devices, such as printers, scanners, multi-function devices, photocopy machines, fax machines, and the like. Embodiments are also to methods and systems for installing rendering devices.

### BACKGROUND OF THE INVENTION

The ability to install and configure a rendering device connected to a computer network can present a variety of challenges to both users and administrators. Device drivers, for example, must be installed and configured properly. Drivers can be employed in computer system configurations to interface between devices and software applications. Each device typically employs its own set of specialized commands that are known only to the driver corresponding to the device. In contrast, software applications typically access a device by using generic commands. Thus, in order to perform a task, a driver typically accepts a generic command from a software application and translates it into a specialized command that is understood by the device used to perform the task.

A printer driver can be configured to selectively provide text and/or graphics on paper. A printer may utilize one of a variety of techniques, including striking a hammer or pins against an ink ribbon, spraying ink at a sheet of paper, providing a chain of characters or pins that print a line at a time, pushing heated pins against heat sensitive paper, or utilizing laser beams, liquid crystals, or light-emitting diodes to produce an image on a drum. Each type of printer utilizes a particular printer driver, which feeds data to the printer with the use of specialized control commands established for the printer.

A user installs/updates printer drivers that are accessible by the computer system. In one technique, a printer driver is installed manually by employing an install program to transfer a copy of the printer driver from a storage medium (e.g., floppy diskette, compact disk, etc.) to the computer system. While this technique allows for the installation or updating of a printer driver, the technique suffers in that the user must know where to locate the printer driver, manually install the driver, be aware that an updated version of the printer driver exists, and reboot the computer system. Further, the installation/update of a printer driver may not be performed while the computer system is printing.

Another technique utilizes a web site as a common location for obtaining a printer driver in the performance of an installation/update of the printer driver. Typically, the website is provided by the manufacturer of the printer driver to enable a user to visit the website and download an updated version of the printer driver. Once downloaded, the user may invoke an installation program and manually install the updated version of the printer driver. While this technique facilitates the ability of a user to locate a printer driver, the user must still manually install the driver, be aware that an updated version of the printer driver exists, and possibly reboot the computer system. Moreover, the installation/update of a printer driver through the utilization of a website cannot be performed while the printer driver is locked in memory (e.g. while printing).

Based on the foregoing, it can be appreciated that enabling computer network users the ability to selectively install rendering devices, such as printers, onto their client computer has always been a problem for network or system administrators. Traditionally, the user is forced to work with the rending device already installed on his or client computer. Installing a new rendering device can prove to be a technical and time-consuming challenge. The user typically must input many parameters, match drivers and attempt varying installation methods.

Driver files generally differ according to make or model of the particular rendering device (e.g., a printer, scanner, fax, etc) and the particular type of Operating System (OS) in use. One problem with this arrangement is that a person searching for a driver file must pair the make and model of their rendering device with that of the driver file make model, while also similarly pairing the OS type.

Another common problem encountered in such configurations is that when a user locates the driver file, the user may also in fact locate files that have not been “blessed” by the network administrator; that is, such files may have not been tested for their appropriateness to the user's environment or computer type. The workstation, computer and/or rendering device at issue thus may not perform optimally.

Printer driver installation for a new computer is therefore an involved situation that either requires an explanation to the user of how to install a printer driver, including the use of the installation program, or the administrators must perform the installation themselves. Often, installation programs are not user friendly in software deployments, and providing information to the user on how to install the program may actually be more painful than the administrators simply performing the installation themselves due to the complexity of the task involved.

The solution described herein with respect to particular embodiments therefore removes the “guess work” involved in the printer and driver installation process, and also enabling a network or system administrator to control which files are utilized for the printer installations

### BRIEF SUMMARY

It is a feature of the present invention to provide improved data-processing methods and systems.

It is also a feature of the present invention to provide improved methods and systems for configuring rendering devices, such as printers, scanners, multi-function devices, photocopy machines, fax machines, and the like.

It is also a feature of the present invention to provide improved methods and systems for installing rendering devices.

Aspects of the present invention relate to methods and systems for configuring, organizing and installing rendering devices in communication with a computer network. In generally, rendering device installation settings can be configured by an administrator utilizing an administration tool for automatically configuring a rendering device associated with a computer network in response to input by an administrator, wherein the computer network includes one or more client computers and one or more servers. A displayable icon and/or a queue can be automatically created in one or more of the client computers, in response to launching the administration tool.

Thereafter, an attempt can be automatically made to install the particular rendering device on one or more of the client computers based on the rendering device installation settings previously configured by the administrator via the administration tool, thereby permitting the administrator to control and organize rendering device installation options. The administration tool for automatically configuring a rendering device can be launched in response to a user selection of a particular rendering device from among a plurality of rendering devices comprising one or more rendering devices.

The display icon and queue can be automatically appended to an electronic folder dedicated to information associated with one or more of the rendering devices connected to the computer network. The queue itself can be automatically created and thereafter mapped to one or more client computers. TCP/IP rendering can be enabled via the one or more of the rendering devices utilizing a driver available locally on the client computer. TCP/IP rendering can also be enabled via one or more rendering devices utilizing a drive available in a central repository within the computer network.

Additionally, a network interface can be established within a rendering device that permits the administrator to configure an installation of the rendering device, wherein the rendering device communicates with a computer network. The installation of the rendering device can be automatically configured utilizing the network interface, in response to a user input by the administrator, thereby permitting the administrator to a particular user installation configuration experience and installation features associated with a rendering device with the computer network. The rendering device can be automatically contacted, in response to a selection of a rendering device by a user, and the particular user installation configuration and installation features downloaded. Thereafter, installation defaults can be generated and set based on the downloaded particular user installation configuration and installation features.

### BRIEF DESCRIPTION OF THE DRAWINGS

The particular values and configurations discussed in these non-limiting examples can be varied and are cited merely to illustrate one or more embodiments and are not intended to limit the scope thereof.

FIG. 1 illustrates a pictorial representation of a data-processing system in which one or more embodiments can be implemented;

FIG. 2 illustrates a block diagram of a representative hardware environment of the processing unit of the data-processing system depicted in FIG. 1;

FIG. 3 illustrates a block diagram of a network in which one or more embodiments can be implemented;

FIG. 4 illustrates a block diagram illustrative of a client/server architecture system in which one or more embodiments can be implemented;

FIG. 5 illustrates a detailed block diagram of a client/server architectural system in which one or more embodiments can be implemented;

FIG. 6 illustrates a high-level network diagram illustrative of a computer network, in which one or more embodiments can be implemented;

FIG. 7 illustrates a high-level flow chart of operations depicting logical operational steps that can be implemented in accordance with a first embodiment; and

FIG. 8 illustrates a high-level flow chart of operations depicting logical operational steps that can be implemented in accordance with a second embodiment.

### DETAILED DESCRIPTION OF THE INVENTION

The particular values and configurations discussed in these non-limiting examples can be varied and are cited merely to illustrate embodiments and are not intended to limit the scope of the invention.

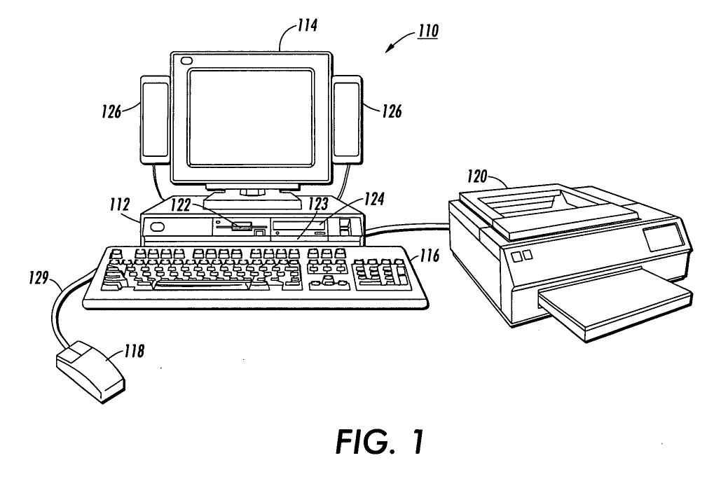

With reference now to the figures and in particular with reference to FIG. 1-3, there is depicted an example computer or data-processing system in which one or more embodiments can be implemented. As depicted in FIG. 1, data-processing system 110 includes processing unit 112, display device 114, keyboard 116, pointing device 118, rendering device 120, and speakers 126. Rendering device 120 can be implemented as a device such as a printer and/or scanner. The term “data-processing system” as utilized herein can be utilized interchangeably with the term “computer” to refer to the same device or machine. Note that rendering device 120 can be implemented not only as a printer, scanner, fax machine, copy machine and/or a combination thereof (e.g., a multi-function device), but can also be implemented as devices, such a Personal Digital Assistant (PDA), Web cam, SAN, AV server, and so forth.

Processing unit 112 receives input data from input devices such as keyboard 116, pointing device 118, and local area network interfaces (not illustrated) and presents output data to a user via display device 114, printer 120, and speakers 126. Because processing unit 112 can be networked into a computer network, devices such as rendering device 120 can function as a network device such as a network scanner or multifunction device. Data-processing system 110 thus can function not only as a stand-alone desktop personal computer, but can also function as a networked data-processing system with multifunction capabilities such as printing, scanning, copying and so forth.

Keyboard 116 is that part of data-processing system 110 that resembles a typewriter keyboard and that enables a user to control particular aspects of the computer. Because information flows in one direction, from keyboard 114 to processing unit 112, keyboard 116 functions as an input-only device. Functionally, keyboard 116 represents half of a complete input/output device, the output half being video display terminal 114. Keyboard 116 includes a standard set of printable characters presented in a “QWERTY” pattern typical of most typewriters. In addition, keyboard 116 includes a calculator-like numeric keypad at one side. Some of these keys, such as the “control,” “alt,” and “shift” keys can be utilized to change the meaning of another key. Other special keys and combinations of keys can be utilized to control program operations or to move either text or cursor on the display screen of video-display terminal 114.

Video-display terminal 114 generally operates as the visual output of data-processing system 110. As indicated herein, video-display terminal 114 can be a cathode-ray tube (CRT) based video display well known in the art of computer hardware. But, with a portable or notebook-based computer, video-display terminal 114 can be replaced with a liquid crystal display (LCD) based or gas, plasma-based, flat-panel display.

Pointing device 118 is preferably utilized in conjunction with a graphical user-interface (GUI) in which hardware components and software objects are controlled through the selection and the manipulation of associated, graphical objects displayed within display device 114. Although data-processing system 110 is illustrated with a mouse for pointing device 118, other graphical-pointing devices such as a graphic tablet, joystick, track ball, touch pad, or track pad could also be utilized. Pointing device 118 features a casing with a flat bottom that can be gripped by a human hand. Pointing device 118 can include buttons on the top, a multidirectional-detection device such as a ball on the bottom, and cable 129 that connects pointing device 118 to processing unit 112.

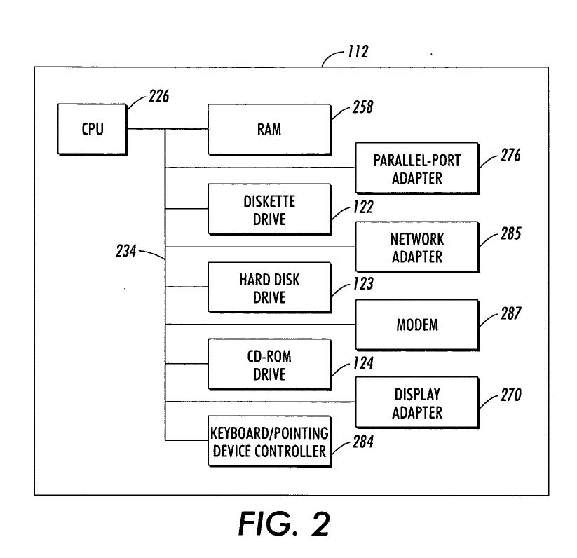

To support storage and retrieval of data, processing unit 112 further includes diskette drive 122, hard-disk drive 123, and CD-ROM drive 124, which are interconnected With other components of processing unit 112, and which are further described below under the description for FIG. 2. Data-processing system 110 can be implemented utilizing any suitable computer. But, a preferred embodiment of the present invention can apply to any hardware configuration that allows the display of windows, regardless of whether the computer system is a complicated, multi-user computing apparatus, a single-user workstation, or a network appliance that does not have non-volatile storage of its own.

Referring to FIG. 2, there is depicted a block diagram of the principal components of processing unit 112. CPU 226 is connected via system bus 234 to RAM (Random Access Memory) 258, diskette drive 122, hard-disk drive 123, CD-ROM drive 124, keyboard/pointing-device controller 284, parallel-port adapter 276, network adapter 285, display adapter 270, and modem 287. Although the various components of FIG. 2 are drawn as single entities, each may consist of a plurality of entities and may exist at multiple levels.

Processing unit 112 includes central processing unit (CPU) 226, which executes instructions. CPU 226 includes the portion of data-processing system 110 that controls the operation of the entire computer system, including executing the arithmetical and logical functions contained in a particular computer program. Although not depicted in FIG. 2, CPU 226 typically includes a control unit that organizes data and program storage in a computer memory and transfers the data and other information between the various parts of the computer system. CPU 226 generally includes an arithmetic unit that executes the arithmetical and logical operations, such as addition, comparison, and multiplication. CPU 226 accesses data and instructions from and stores data to volatile RAM 258.

CPU 226 can be implemented, for example, as any one of a number of processor chips, or any other type of processor, which are available from a variety of vendors. Although data-processing system 110 is shown to contain only a single CPU and a single system bus, the present invention applies equally to computer systems that have multiple CPUs and to computer systems that have multiple buses that each performs different functions in different ways.

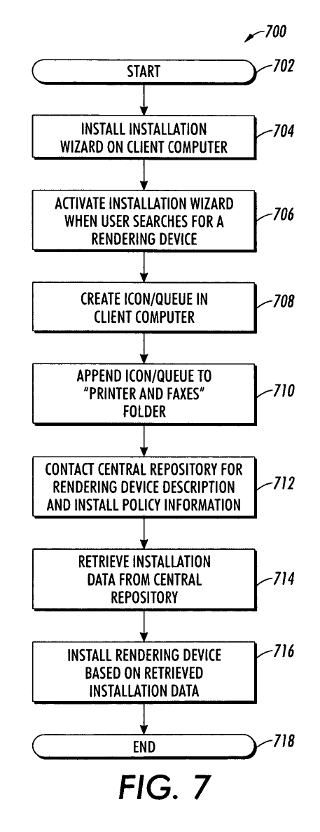

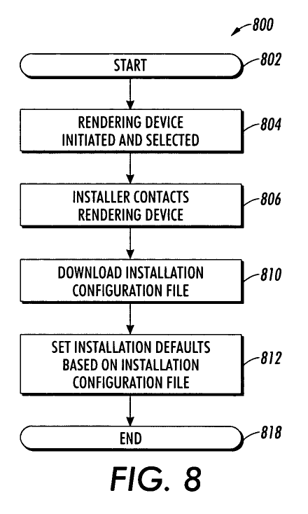

RAM 258 can be composed of a number of individual, volatile-memory modules that store segments of operating system and application software while power is supplied to data-processing system 110. For example, the methodology depicted in FIGS. 7-8 herein can be implemented in the context of such individual, volatile-memory modules. The software segments are partitioned into one or more virtual-memory pages that each contains a uniform number of virtual-memory addresses. When the execution of software requires more pages of virtual memory than can be stored within RAM 258, pages that are not currently needed are swapped with the required pages, which are stored within non-volatile storage devices 122 or 123. RAM 258 is a type of memory designed such that the location of data stored in it is independent of the content. Also, any location in RAM 258 can be accessed directly without needing to start from the beginning.

Hard-disk drive 123 and diskette drive 122 are electromechanical devices that read from and write to disks. The main components of a disk drive are a spindle on which the disk is mounted, a drive motor that spins the disk when the drive is in operation, one or more read/write heads that perform the actual reading and writing, a second motor that positions the read/write heads over the disk, and controller circuitry that synchronizes read/write activities and transfers information to and from data-processing system 110.

A disk itself is typically a round, flat piece of flexible plastic (e.g., floppy disk) or inflexible metal (e.g. hard disk) coated with a magnetic material that can be electrically influenced to hold information recorded in digital form. A disk is, in most computers, the primary method for storing data on a permanent or semi permanent basis. Because the magnetic coating of the disk must be protected from damage and contamination, a floppy disk (e.g., 5.25 inch) or microfloppy disk (e.g., 3.5 inch) is encased in a protective plastic jacket. But, any size of disk could be used. A hard disk, which is very finely machined, is typically enclosed in a rigid case and can be exposed only in a dust free environment. Keyboard/pointing-device controller 284 interfaces processing unit 112 with keyboard 116 and graphical-pointing device 118. In an alternative embodiment, keyboard 116 and graphical-pointing device 118 may possess separate controllers. Display adapter 270 can translate graphics data from CPU 226 into video signals utilized to drive display device 114.

Finally, processing unit 112 includes network adapter 285, modem 287, and parallel-port adapter 276, which facilitate communication between data-processing system 110 and peripheral devices or other computer systems. Parallel-port adapter 276 transmits printer-control signals to printer 120 through a parallel port. Network adapter 285 connects data-processing system 110 to an un-illustrated local area network (LAN). A LAN provides a user of data-processing system 110 with a means of electronically communicating information, including software, with a remote computer or a network logical-storage device. In addition, a LAN supports distributed processing, which enables data-processing system 110 to share a task with other computer systems linked to the LAN, which can also be implemented in the context of a wireless local area network (WLAN).

Modem 287 supports communication between data-processing system 110 and another computer system over a standard telephone line. Furthermore, through modem 287, data-processing system 110 can access other sources such as a server, an electronic bulletin board, and the Internet or the well-known World Wide Web.

The configuration depicted in FIG. 1 is but one possible implementation of the components depicted in FIG. 2. Portable computers, laptop computers, and network computers or Internet appliances are other possible configurations. The hardware depicted in FIG. 2 may vary for specific applications. For example, other peripheral devices such as optical-disk media, audio adapters, or chip-programming devices, such as PAL or EPROM programming devices well known in the art of computer hardware, may be utilized in addition to or in place of the hardware already depicted.

As will be described in detail below, aspects of the embodiments disclosed herein pertain to specific method steps implementable on computer systems. Embodiments can also be implemented as a computer program-product for use with a computer system, which can be implemented as devices such as networked computer workstations, computer desktop and peripheral devices, servers and the like. The programs defining the functions of the embodiment disclosed herein can be delivered to a computer via a variety of signal-bearing media, which include, but are not limited to: (a) information permanently stored on non-writable storage media (e.g., read-only memory devices within a computer such as CD-ROM disks readable by CD-ROM drive 124); (b) alterable information stored on writable storage media (e.g., floppy disks within diskette drive 122 or hard-disk drive 123); or (c) information conveyed to a computer by a communications media, such as through a computer or telephone network, including wireless communications. Such signal-bearing media, when carrying computer-readable instructions that direct the functions of one or more embodiments, and/or represent alternative embodiments.

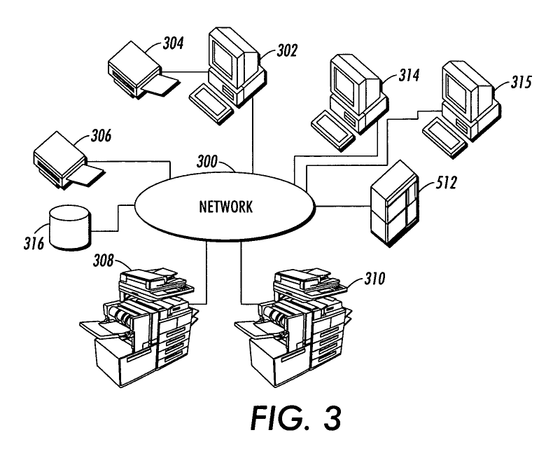

FIG. 3 illustrates a block diagram of a network 300 in which one or more embodiments can be implemented. Network 300 can be implemented as a computer network through which a variety of data-processing system devices can communicate. An example of network 300 is a LAN. For example, network 300 can communicate with a server 312. Additionally a computer 302 can be linked to a multi-function rendering device 304 or another multi-function rendering device 306 can be linked directly through network 300. Additionally, computer workstations 314 and/or 315 can be linked to network 300 along with one or more digital copiers 308 and 310.

Note that computer 302 and computer workstations 314/315 are generally analogous to data-processing system 110. Digital copiers 308 and 310 have the capability to scan documents. Thus, documents scanned via copiers 308 and 310 can be saved as computer files (e.g., JPEG, PDF, TIFF, etc) and transmitted to computer 302 for storage within a memory location thereof.

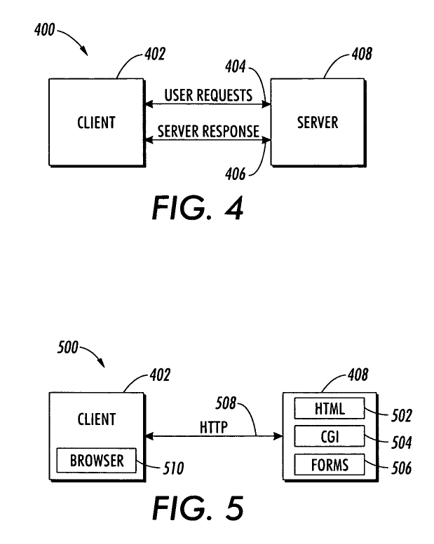

The documents stored within a memory location of computer 302 can then be retrieved via computer 302 and rendered via, for example, rendering devices 304 and/or 306, or copiers 308 and/or 310. Note that documents and data can also be stored within a database 316 that functions as a central repository within network 300. An example of an MRP database is disclosed in further detail herein with respect to FIG. 4 (i.e., see MRP database 409). Computer 302 is generally analogous to data-processing system 110 of FIG. 1, and thus, the documents scanned via copiers 508 can be stored within a memory location of data-processing system 110 and process via a processor such as CPU 226 and/or a CPU associated within any of the other rendering devices, such rendering devices 304, 306 and/or copiers 308, 310.

Note that a variety of different types of rendering devices can be adapted for utilization with one or more embodiments. For example, different types of copiers can be utilized to implement copiers 308 and 310. An example of such a copier is disclosed in U.S. Pat. No. 6,636,899, “Architecture for Software for Remote Maintenance of a Machine Such as a Copier,” which is assigned to the Xerox Corporation and issued to Rabb, et al on Oct. 21, 2003. Another example of a copier, which can be utilized in accordance with an alternative embodiment, is disclosed in U.S. Pat. No. 6,587,227, “Copier Having Contoured Track Guides,” which is also assigned to the Xerox Corporation and issued to Jack K. Fullerton on Jul. 1, 2003.

A further example of a copier, which can be utilized in accordance with an alternative embodiment, is disclosed in U.S. Pat. No. 6,175,714, “Document Control System and Method for Digital Copiers,” which is assigned to the Xerox Corporation and issued to Peter A. Crean on Jan. 16, 2001. Another example of a copier, which can be utilized in accordance with an alternative embodiment, is disclosed in U.S. Pat. No. 6,057,930, “Architecture for a Digital Copier and Printer for Handling Print Jobs Associated with a Network,” which is assigned to the Xerox Corporation and issued to Blossey et al on May 2, 2000. U.S. Pat. Nos. 6,636,899, 6,587,227, 6,175,714 and 6,057,930 are incorporated herein by reference.

FIG. 4 illustrates a block diagram illustrative of a client/server architecture system 400 in which one or more embodiments can be implemented. It can be appreciated by those skilled in the art that the system illustrated with respect to FIGS. 4 to 6 generally describes an example of one type of computer network in which the embodiments disclosed can be implemented. It can be appreciated that other types of computer networks can also be utilized in accordance with alternative embodiments of the present invention, such as, for example, token ring networks, Intranets or organizationally dedicated computer networks rather than a more open computer network, such as the Internet.

FIGS. 4-6 are thus presented for illustrative purposes only and are not considered limiting features of the As indicated in FIG. 4, user requests 404 for data can be transmitted by a client 402 (or other sources) to a server 408. Server 408 is analogous, for example, to sever 312 depicted in FIG. 3. Server 408 can be implemented as a remote computer system accessible over the Internet, the meaning of which is known, or other communication networks. Note that the term “Internet” is well known in the art and is described in greater detail herein. Also note that the client/server architecture described in FIGS. 4, 5 and 6 represents merely an exemplary embodiment. It is believed that the present invention can also be embodied in the context of other types of network architectures, such as, for example company “Intranet” networks, token-ring networks, wireless communication networks, and the like.

Server 408 can perform a variety of processing and information storage operations. Based upon one or more user requests, server 408 can present the electronic information as server responses 406 to the client process. The client process may be active in a first computer system, and the server process may be active in a second computer system, communicating with one another over a communications medium, thus providing distributed functionality and allowing multiple clients to take advantage of information processing and storage capabilities of the server, including information retrieval activities such as retrieving documents from a managed service environment.

FIG. 5 illustrates a detailed block diagram of a client/server architectural system 500 in which one or more embodiments can be implemented. Although the client and server are processes that are generally operative within two computer systems, such processes can be generated from a high-level programming language, which can be interpreted and executed in a computer system at runtime (e.g., a workstation), and can be implemented in a variety of hardware devices, either programmed or dedicated.

Client 402 and server 408 communicate utilizing the functionality provided by HTTP. Active within client 402 can be a first process, browser 410, which establishes connections with server 408, and presents information to the user. Any number of commercially or publicly available browsers can be utilized in various implementations in accordance with one or more embodiments. For example, a browser can provide the functionality specified under HTTP. A customer administrator or other privileged individual or organization can configure authentication policies, as indicated herein, using such a browser.

Server 408 can execute corresponding server software, such as a gateway, which presents information to the client in the form of HTTP responses 508. A gateway is a device or application employed to connect dissimilar networks (i.e., networks utilizing different communications protocols) so that electronic information can be passed or directed from one network to the other. Gateways transfer electronic information, converting such information to a form compatible with the protocols used by the second network for transport and delivery. Embodiments can employ Common Gateway Interface (CGI) 504 for such a purpose.

The HTTP responses 508 generally correspond with “Web” pages represented using HTML, or other data generated by server 408. Server 408 can provide HTML 502. The Common Gateway Interface (CGI) 504 can be provided to allow the client program to direct server 408 to commence execution of a specified program contained within server 408. Through this interface, and HTTP responses 508, server 408 can notify the client of the results of the execution upon completion.

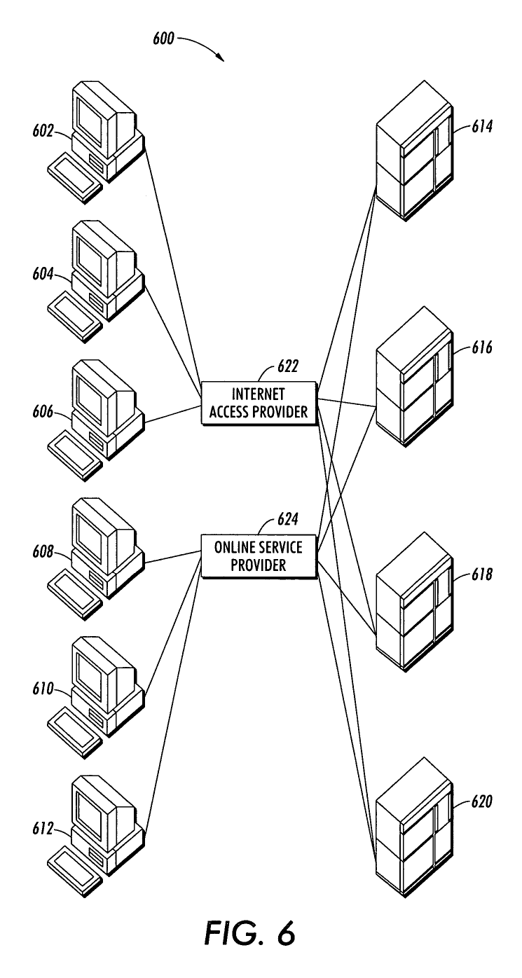

FIG. 6 illustrates a high-level network diagram illustrative of a computer network 600, in which embodiments can be implemented. Computer network 600 can be representative of the Internet, which can be described as a known computer network based on the client-server model discussed herein. Conceptually, the Internet includes a large network of servers 614-620 that are accessible by clients 602-612, typically users of personal computers, through some private Internet access provider 622 or an on-line service provider 304.

Each of the clients 602-612 can operate a browser to access one or more servers 614-620 via the access providers. Each server 614-620 can operate a so-called “Web site” that supports files in the form of documents and web pages. A network path to servers 614-620 can be generally identified by a Universal Resource Locator (URL) having a known syntax for defining a network collection. Computer network 600 can thus be considered a “Web-based” computer network.

FIG. 7 illustrates a high-level flow chart 700 of operations depicting logical operational steps that can be implemented in accordance with a first embodiment. Flow chart 700 depicts a methodology for installing a driver for a rendering device by one of several means, which are configured according to a central repository that includes driver data. Note that as utilized herein, the term “driver” can generally refer to electronic devices (e.g., software modules) employed in a data-processing system configuration to interface between devices/components and software applications. Each device typically employs its own set of specialized commands that are known only to the driver corresponding to the device. In contrast, software applications typically access a device by using generic commands. Thus, in order to perform a task, a driver typically accepts a generic command from a software application and translates it into a specialized command that is understood by the device used to perform the task. An example of a driver is a printer driver.

The process can be initiated, as indicated at block 702. Thereafter, as depicted at block 704, an operation can be performed in which an installation “wizard” is installed on a client computer of a network, such as, for example, network 600 depicted in FIG. 6. Note that as utilized herein, the term “wizard” generally refers to a software utility or program within a software application that assists a user in utilizing the software application to perform a particular task. The installation wizard described herein can be downloaded from a central web server. This enables the logic (i.e., installation wizard) to be updated at one place propagate the changes to all clients the next time an attempt is made to install a printer/rendering device. The solution described here not only stores the settings and driver at a central place, but also the installation logic or wizard on a central server.

Such an installation wizard operates as an administration tool for automatically configuring a rendering device associated with a computer network in response to input by an administrator. The installation wizard generally automates the process of rendering device installation/configuration on a user's machine or client computer, thereby shielding the user from the usual installation complexity. The user need not worry about locating the appropriate driver or having specific knowledge about the rendering device's make-model specifications.

The installation wizard can be installed on the client machine and activated when the user searches for a particular rendering device (e.g., printer, copier, scanner, multi-function device, etc.), as indicated at block 706. Next, as indicated at block 708, the installation wizard can thereafter create a rendering device icon/queue in a client computer, such as, for example, one or more of clients 602-612 depicted in FIG. 6. The rendering device icon/queue can then be appended to a “printers and fax” folder accessible by the client computer, as indicated at block 710. Note that as utilized herein, the term “folder” generally refers to an object that contains multiple documents, and which is utilized to organize information. Such electronic objects are typically implemented in graphical user interface (GUI) environments such as the well-known “Windows” and Macintosh environments. Such “folders” are also referred to sometimes as directories.

Thereafter, as depicted at block 712, the central repository (e.g., a central server) can be contacted for rendering device description and installation policy information, which can be retrieved as, indicated at block 714 and utilized as depicted at block 716 to install the driver (e.g., a printer driver) with a minimum amount of user intervention. The process can then terminate, as indicated at block 718.

The installation wizard therefore takes into account rendering device installation options enabled by the administrator and its order. It then attempts to install the rendering device on the client computer without any input from the user. It locates the best-fit driver either on the client machine or the central repository (e.g., a central driver repository, using an algorithm that maps the driver to a printer make-model (i.e., a particular printer). The rendering device queue can thus be configured, permitting the user to render documents via the selected rendering device.

The installation wizard or rendering device administration tool described above can support a numbering of installation techniques. For example, such an administration tool can support print server based queues, and can map network queues to the client machine or client computer. Additionally, such an administration tool can enable direct TCP/IP rendering utilizing drivers located locally on a client computer. Note that although TCP/IP is discussed herein with respect to particular embodiments, it can be appreciated that the embodiments disclosed herein are not limited To TCP/IP, but can be implemented utilizing any number of communication protocols. TCP/IP is thus disclosed and discussed herein for general illustrative and edification purposes only.

Note that administration tool discussed herein can enable direct TCP/IP (i.e., or another communication protocol) rendering utilizing drivers available in the central repository described above, which can function as a central enterprise driver repository. Finally, such an administration tool can enable direct TCP/IP rendering utilizing a generic PostScript driver or by utilizing mobile rendering device components. Thus, the administrator can control which of the aforementioned installation techniques are made available to the client computers, and also in which order such installations can be attempted.

A number of advantages can accrue from the use of the installation wizard or administration tool described above. For example, a single click rendering device installation can be implemented so that the user does not have to worry about rendering device configuration settings, make-model specifications, and drivers. Because such an administration tool supports multiple rendering device installation techniques (e.g., network print server queue, direct printing using client/repository/generic driver), one of these installation techniques is bound to function properly, thereby enabling the user to render a document to the rendering device of their choice. Such an administration tool can also minimize support calls and increase user and administrator productivity.

FIG. 8 illustrates a high-level flow chart 800 of operations depicting logical operational steps that can be implemented in accordance with a second embodiment. Flow chart 800 generally describes a methodology that enables an administrator to utilize a network interface (e.g., a web interface), which is established within the rendering device itself in order to configure the rendering device installation process to ease the work for everyone involved. But utilizing the network interface in the rendering device hardware, the administrator can configure the user installation experience and determine whether the installer would install items such as, for example, manuals, web links, and other components. Note that the rendering device described herein can check a centralized server/device if necessary.

As indicated at block 802, the process can be initiated. Next, as depicted at block 804, a rendering device can be initiated and selected through any means available (e.g., smart web install, command line, user selection, etc.). Following printer initiation and selection, the install can contact the rendering device, as indicated at block 806, to download the installation configuration file, as depicted thereafter at block 808. Next as depicted at block 810, installation defaults can be set based on the installation configuration file, rather than posting questions to the user for installation purposes. The process can then terminate, as indicated at block 812. Such a methodology therefore allows the administrator to set-up, for each rendering device, a custom installation experience to streamline the installation process and standardize the installation of a rendering device, such as, for example, a printer, scanner, fax machine, photocopy machine, multi-function rendering device, and the like. Such a methodology readily lends itself to automatic installation through login scripts.

In order to further explain the methodology depicted in FIG. 8, reference can be made to various scenarios involving a computer network such as network 300 of FIG. 3 and/or network 600 of FIG. 6 in which at least twenty printers (i.e., printers 1-10) are implemented. In a first scenario, an administrator configures the installation of printer 10. The user administrator opens an information services application in printer 10 and then browses to the installation configuration page. The administrator then selects an option for the installation of printer manuals associated with printer 10, but does not select an option relating to the installation of bookmarks nor to the installation of videos. The administrator then enables the installation configuration and “clicks” utilizing a pointing device such as a “mouse” to save these changes.

In a second scenario, a user A installs printer 20 by first inserting a CD into his or her client computer to begin the installation process. The user selects printer 20 from the installation program, which then contacts printer 20 and checks for installation configuration settings. In this scenario, the setting is not enabled. The installer prompts user A to select installation options. The user opts not to install the manuals, but does opt to install the bookmarks and videos. The installation is then complete. User A has therefore selected the opposite of what the Administrator chose earlier, as described above with respect to the first scenario.

In a third scenario, a user B desires to install printer 10. User B inserts the CD into his or her client computer (i.e., which differs from the client computer associated with user A) in order to initiation the installation process. User B selects printer 10 from the installation program, which then contacts printer 10 and checks for installation configuration settings. The installation configuration is now enabled. The installation program downloads the installation configuration settings and makes installation decisions based on the settings in the installation configuration file. The installation is now complete and the settings are as the administrator has dictated.

In a fourth scenario, a user C desires to install printer 10 from a hard drive associated with and/or integrated with printer 10. First, the administrator e-mails to user C, a URL (Uniform Resource Locator) to printer 10 with instructions to click the “Install Printer Drivers” URL, and then click the windows printer driver installer and thereafter click “run from source” instructions. User C then clicks the URL, followed by the “Install Printer Drivers” URL, and then clicks the windows printer driver installer URL and clicks “run from source.” The installer detects the printer and contacts printer 10 to check for installation configuration settings. The installation configuration is now enabled. The installation program downloads the installation configuration settings and makes installation decisions based on the settings in the installation configuration file. The installation process is now complete, and the settings are as the administrator has dictated.

Note that the methodology disclosed above with respect to FIGS. 7-8 can be implemented as a computer program-product as described above that is composed of one or more modules. Such modules can constitute software modules. In the computer programming arts, a software module can be typically implemented as a collection of routines and data structures that performs particular tasks or implements a particular abstract data type.

Software modules generally are composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. The term module, as utilized herein can therefore refer to software modules or implementations thereof. Such modules can be utilized separately or together to form a program product that can be implemented through signal-bearing media, including transmission media and recordable media.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

The embodiments of the invention in which an exclusive property or right is claimed are defined as follows. Having thus described the invention what is claimed is:

1. A method, comprising:
configuring rendering device installation settings utilizing an administration tool for automatically configuring a rendering device associated with a rendering service and a computer network in response to input by an administrator, wherein said computer network includes at least one client computer and at least one server;
automatically offering said rendering services to said at least one client computer of said computer network in response to launching said administration tool; and
thereafter automatically attempting to install said particular rendering device on said at least one client computer based on said rendering device installation settings previously configured by said administrator via said administration tool, in response to an acceptance of said rendering service by said at least one client thereby permitting said administrator to control and organize rendering device installation options.

2. The method of claim 1 further comprising:
launching said administration tool for automatically configuring a rendering device, in response to a user selection of a particular rendering device from among a plurality of rendering devices comprising at least one rendering device.

3. The method of claim 1 further comprising:
representing said rendering service associated with said rendering device in said administration tool as a displayable icon.

4. The method of claim 2 further comprising:
automatically appending said displayable icon to an electronic folder dedicated to information associated with at least one rendering device.

5. The method of claim 1 further comprising:
generating a queue of rendering devices;
automatically creating said queue or rendering devices in at least one client computer of said computer network; and
thereafter mapping said queue to said at least one client computer.

6. The method of claim 1 further comprising
enabling TCP/IP rendering via said at least one rendering device utilizing a driver available locally on said client computer.

7. The method of claim 1 further comprising
enabling TCP/IP rendering via said at least one rendering device utilizing a drive available in a central repository within said computer network.

8. The method of claim 1 wherein said rendering service comprises printing.

9. The method of claim 1 wherein said rendering service comprises scanning.

10. A system, comprising:
an administration tool for configuring installation settings for a rendering device associated with a rendering service and a computer network that includes at least one client computer and at least one server, wherein said rendering service is automatically offered to said at least one client computer of said computer network in response to launching said administration tool;
a displayable icon and a queue, which graphically represent said rendering service in said administration tool and is automatically created in at least one client computer of said computer network, in response to launching said administration tool; and
a module for automatically attempting to install said particular rendering device on said at least one client computer based on said installation settings previously configured by said administrator via said administration tool, in response to an acceptance of said rendering service by said at least one client, thereby permitting said administrator to control and organize rendering device installation options.

11. The system of claim 10 wherein said administration tool for automatically configuring a rendering device can be launched, in response to a user selection of a particular rendering device from among a plurality of rendering devices comprising at least one rendering device.

12. The system of claim 10 further comprising a module for automatically appending said displayable icon and queue to an electronic folder dedicated to information associated with at least one rendering device.

13. The system of claim 10 wherein said queue is automatically created and thereafter mapped to said at least one client computer.

14. The system of claim 10 wherein TCP/IP rendering is enabled via said at least one rendering device utilizing a driver available locally on said client computer.

15. The system of claim 10 wherein TCP/IP rendering is enabled via said at least one rendering device utilizing a drive available in a central repository within said computer network.

16. A method, comprising:
establishing a network interface within a rendering device that permits an administrator to configure an installation of said rendering device, wherein said rendering device communicates with a computer network comprising at least one client computer and at least one server; and
automatically configuring said installation of said rendering device utilizing said network interface, in response to a user input by said administrator, thereby permitting said administrator to a particular user installation configuration experience and installation features associated with a rendering device with said computer network.

17. The method of claim 16 further comprising:
automatically contacting said rendering device, in response to a selection of a rendering device by a user;
downloading said particular user installation configuration and installation features; and
thereafter generating and setting installation defaults based on said downloaded particular user installation configuration and installation features.

18. The method of claim 16 wherein said network interface comprises a web interface and said computer network comprises a client-server network.

19. The method of claim 16 wherein said rendering device comprises at least one of the following: a printer, a copy machine, a scanner, a multifunction device, or a combination thereof.

20. The method of claim 16 wherein said at least one server comprises said rendering device.

21. A system, comprising:
a network interface established within a rendering device that permits an administrator to configure an installation of said rendering device, wherein said rendering device communicates with a computer network comprising at least one client computer and at least one server; and
a module for automatically configuring said installation of said rendering device utilizing said network interface, in response to a user input by said administrator, thereby permitting said administrator to a particular user installation configuration experience and installation features associated with a rendering device with said computer network.

22. The system of claim 21 further comprising:
a module for automatically contacting said rendering device, in response to a selection of a rendering device by a user;
a module for downloading said particular user installation configuration and installation features; and
a module for thereafter generating and setting installation defaults based on said downloaded particular user installation configuration and installation features.

23. The system of claim 21 wherein said network interface comprises a web interface and said computer network comprises a client-server network.

24. The system of claim 21 wherein said rendering device comprises at least one of the following: a printer, a copy machine, a scanner, a multifunction device, or a combination thereof.

25. The system of claim 21 wherein said at least one server comprises said rendering device.
